(19) United States
(12) Patent Application Publication
(10) Pub. No.: US 2026/0121242 A1
(43) Pub. Date: Apr. 30, 2026

(54) BUS BAR

(71) Applicant: Yazaki Corporation, Tokyo (JP)

(72) Inventors: Katsunori SATO, Shizuoka (JP); Tatsuya Oga, Shizuoka (JP); Mariko Nakagawa, Shizuoka (JP); Masato Tanaka, Shizuoka (JP)

(73) Assignee: Yazaki Corporation, Tokyo (JP)

(21) Appl. No.: 19/006,729

(22) Filed: Dec. 31, 2024

(30) Foreign Application Priority Data
Jan. 30, 2024 (JP) 2024-012046

(51) Int. Cl. H01M 50/516; H01M 50/503; H01M 50/522; H01M 50/528

(52) U.S. Cl. CPC H01M 50/516; H01M 50/503; H01M 50/522; H01M 50/528

(57) ABSTRACT

A bus bar includes: a bus bar body that is formed in a flat plate shape and is arranged between one battery cell and an other battery cell adjacent to each other in a battery module in which a plurality of battery cells are arranged, in which the bus bar body is divided into two parts including a first terminal connecting body whose welding target is a first electrode terminal of the one battery cell and a second terminal connecting body whose welding target is a second electrode terminal of the other battery cell.

### CROOSS-REFERENCE TO RELATED APPLICATIONS

The present application claims priority to and incorporates by reference the entire contents of Japanese Patent Application No. 2024-012046 filed in Japan on January 30, 2024.

### BACKGROUND OF THE INVENTION

### 1. Field of the Invention

The present invention relates to a bus bar.

### 2. Description of the Related Art

Hitherto, in a battery module in which a plurality of battery cells are arranged, electrode terminals of adjacent battery cells in an arrangement direction of the plurality of battery cells are arranged are physically and electrically connected by one bus bar. The bus bar includes a first terminal connecting body physically and electrically connected to one electrode terminal and a second terminal connecting body physically and electrically connected to the other electrode terminal. On the other hand, in the battery module, a tolerance absorbing structure is provided in the bus bar in order to absorb a deviation of an inter-terminal pitch within a range of design tolerance due to thermal expansion and thermal contraction of the battery cells and a deviation of an inter-terminal pitch within a range of design tolerance due to assembly tolerance variation of the plurality of battery cells. In the bus bar, the tolerance absorbing structure using a lightening portion such as a notch is provided between the first terminal connecting body and the second terminal connecting body (in other words, a central portion in the arrangement direction of the plurality of battery cells) to absorb the deviation of the inter-terminal pitch. For example, this type of bus bar is disclosed in Japanese Patent Application Laid-open No. 2012-243689.

Meanwhile, in the bus bar, the central portion between the first terminal connecting body and the second terminal connecting body at which the tolerance absorbing structure is provided is most likely to generate heat, and therefore it is necessary to increase heat resistance by, for example, increasing a cross-sectional area of the central portion. However, in the bus bar according to the related art, the tolerance absorbing structure and a heat resistant structure are provided at the same location (the central portion), and there is room for improvement in arrangement of the tolerance absorbing structure.

### SUMMARY OF THE INVENTION

Therefore, an object of the present invention is to provide a bus bar in which a tolerance absorbing structure is arranged at a suitable location.

A bus bar according to one aspect of the invention includes a bus bar body that is formed in a flat plate shape and is arranged between one battery cell and an other battery cell adjacent to each other in a battery module in which a plurality of battery cells are arranged, wherein the bus bar body is divided into two parts including a first terminal connecting body whose welding target is a first electrode terminal of the one battery cell and a second terminal connecting body whose welding target is a second electrode terminal of the other battery cell, at least one of the first terminal connecting body and the second terminal connecting body includes a through-hole that exposes the electrode terminal as the welding target, and a flexible portion that protrudes from an outer peripheral edge portion of the through-hole toward a hole center and has flexibility, and the flexible portion includes a terminal welded portion that is welded to the electrode terminal as the welding target, and a spring portion that is provided between the terminal welded portion and a fixed end on an outer peripheral edge portion side of the through-hole and is elastically deformable in a protruding direction of the spring portion and in an opposite direction to the protruding direction of the spring portion.

A bus bar according to another aspect of the invention includes a first bus bar body formed in a flat plate shape and arranged between one battery cell and an other battery cell adjacent to each other in a battery module in which a plurality of battery cells are arranged; and a second bus bar body physically and electrically connected to the first bus bar body, wherein the first bus bar body includes a notch portion or a through-hole portion for exposing a first electrode terminal of the one battery cell and is divided into two parts including a first terminal connecting body to which the first electrode terminal is electrically connected via the second bus bar body and a second terminal connecting body whose welding target is a second electrode terminal of the other battery cell, and the second bus bar body includes a terminal welded portion that is arranged in the notch portion or the through-hole portion of the first terminal connecting body and is welded to the first electrode terminal, a first bus bar welded portion that is welded to the first terminal connecting body, a second bus bar welded portion that is welded to the first terminal connecting body, a first spring portion that is provided between the terminal welded portion and the first bus bar welded portion and is elastically deformable in an arrangement direction of the terminal welded portion and the first bus bar welded portion and an opposite direction to the arrangement direction of the terminal welded portion and the first bus bar welded portion, a second spring portion that is provided between the terminal welded portion and the second bus bar welded portion and is elastically deformable in an arrangement direction of the terminal welded portion and the second bus bar welded portion and an opposite direction to the arrangement direction of the terminal welded portion and the second bus bar welded portion, and a circuit conductor connecting portion that is physically and electrically connected to a circuit conductor electrically connected to a battery monitoring unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a bus bar of a first specific example in an embodiment;

FIG. 2 is an explanatory view of the bus bar of the first specific example in the embodiment;

FIG. 3 is an explanatory view illustrating an example of followability of a flexible portion when a position of an electrode terminal deviates in a direction orthogonal to an arrangement direction of a plurality of battery cells;

FIG. 4 is an explanatory view illustrating an example of followability of the flexible portion when the position of the electrode terminal deviates in a direction orthogonal to a plane of a first terminal connecting body (a plane of a first electrode terminal);

FIG. 5 is a perspective view illustrating a bus bar of a second specific example in the embodiment;

FIG. 6 is a perspective view illustrating a bus bar of a third specific example in the embodiment;

FIG. 7 is a perspective view illustrating a bus bar of a fourth specific example in the embodiment;

FIG. 8 is a perspective view illustrating a bus bar of a fifth specific example in the embodiment;

FIG. 9 is a perspective view illustrating a bus bar of a sixth specific example in the embodiment;

FIG. 10 is a perspective view illustrating a bus bar of a seventh specific example in the embodiment;

FIG. 11 is a perspective view illustrating one of specifications of a battery module;

FIG. 12 is a perspective view illustrating a bus bar of a first specific example in a modification;

FIG. 13 is an explanatory view for describing a clamping portion of a first bus bar body of the first specific example in the modification; and

FIG. 14 is a perspective view illustrating a bus bar of a second specific example in the modification.

### DETAILED DESCRIPTION OF THE PREFERRED EMBODIMENTS

Hereinafter, an embodiment of a bus bar according to the present invention will be described in detail with reference to the drawings. Note that the present invention is not limited by the embodiment.

### Embodiment

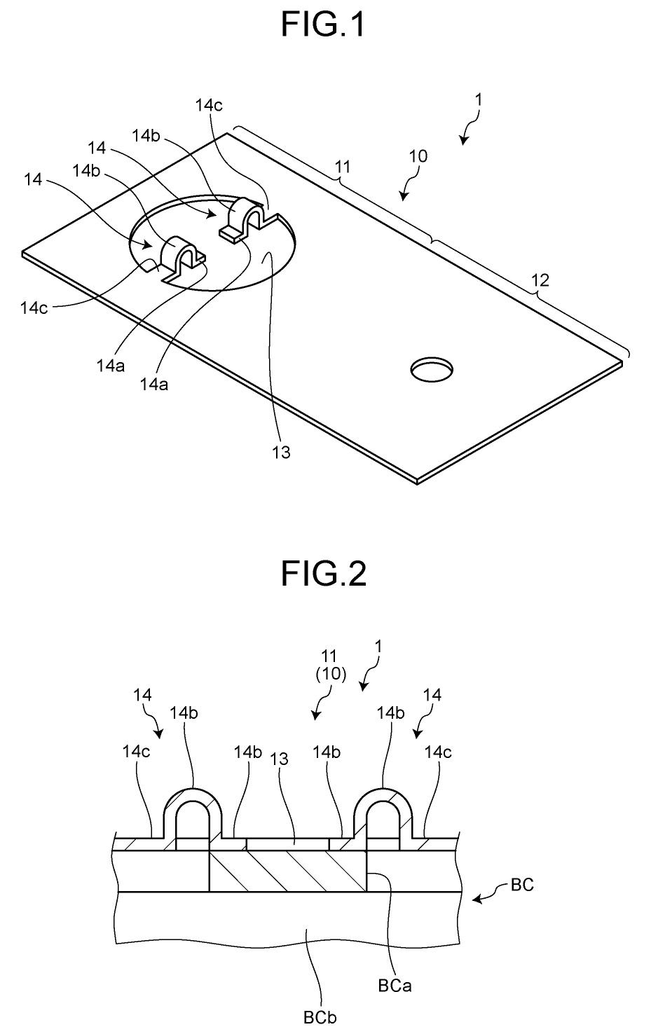

One embodiment of the bus bar according to the present invention will be described with reference to FIGS. 1 to 10.

First, an outline of the bus bar of the present embodiment will be described.

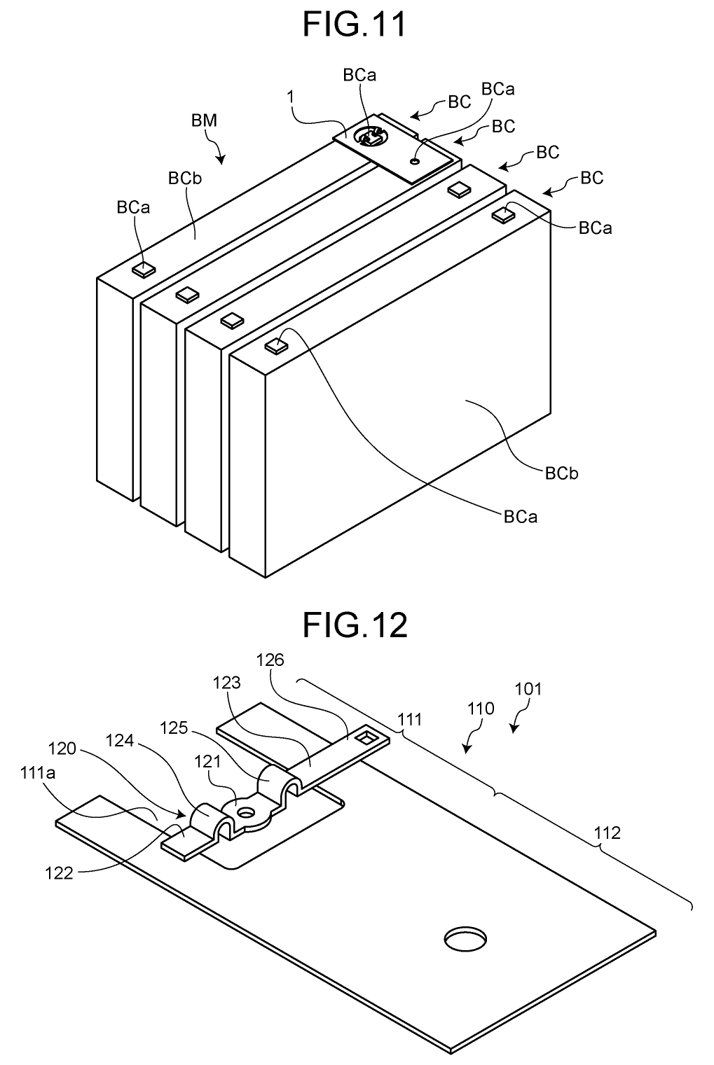

In a battery module BM (FIG. 11) in which a plurality of battery cells BC are arranged (for example, in a single row), the bus bar of the present embodiment physically and electrically connects an electrode terminal BCa of one battery cell BC and an electrode terminal BCa of the other battery cell BC, the one battery cell BC and the other battery cell BC being adjacent to each other in an arrangement direction of the battery cells BC, thereby electrically connecting the electrode terminals BCa to each other. In addition, the bus bar is electrically connected to a battery monitoring unit (not illustrated) via a circuit conductor (not illustrated), thereby causing the battery monitoring unit to monitor a battery state (a voltage, a current, a temperature, or the like) of the battery cell BC. The circuit conductor is, for example, an electric wire, a wiring pattern of a flexible printed circuit board (FPC), or the like.

The battery cell BC includes a cell body BCb and positive and negative electrode terminals BCa (FIG. 11). In the battery cell BC illustrated here, the cell body BCb is formed in a rectangular parallelepiped shape having six outer wall surfaces, and the battery cell BC includes the positive and negative flat-plate-like electrode terminals BCa on one of the six outer wall surfaces. In the plurality of battery cells BC included in the battery module BM, the cell bodies BCb adjacent to each other in the arrangement direction are arranged such that other outer wall surfaces face each other. In the battery module BM, the electrode terminals BCa on one sides of the respective battery cells BC are arranged in the arrangement direction, and the electrode terminals BCa on the other sides of the respective battery cells BC are arranged in the arrangement direction. Note that, in the battery cell BC, the positive electrode flat-plate-like electrode terminal BCa and the negative electrode flat-plate-like electrode terminal BCa may also be respectively provided on different outer wall surfaces among the six outer wall surfaces.

The bus bar of the present embodiment includes a bus bar body formed in a flat plate shape. The bus bar body is arranged between one battery cell BC and the other battery cell BC adjacent to each other.

The bus bar body is divided into two parts including a first terminal connecting body whose welding target is a first electrode terminal BCa of one battery cell BC and a second terminal connecting body whose welding target is a second electrode terminal BCa of the other battery cell BC. At least one of the first terminal connecting body and the second terminal connecting body includes a through-hole that exposes the electrode terminal BCa as the welding target, and a flexible portion protruding from an outer peripheral edge portion of the through-hole toward the hole center and having flexibility. Further, the flexible portion includes a terminal welded portion that is welded to the electrode terminal BCa as the welding target, and a spring portion that is provided between the terminal welded portion and a fixed end on an outer peripheral edge portion side of the through-hole and is elastically deformable in a protruding direction of the spring portion and an opposite direction thereto.

The bus bar of the present embodiment includes the bus bar body having such a shape, so that the spring portion of the flexible portion functions as a tolerance absorbing structure. For example, even in a case where an interval (so-called inter-terminal pitch) in the arrangement direction of the respective electrode terminals BCa of the two adjacent battery cells BC deviates within a range of design tolerance, the bus bar can be welded to the respective electrode terminals BCa by absorbing the deviation of the inter-terminal pitch with the spring portion. In addition, even in a case where the inter-terminal pitch deviates within the range of design tolerance, or a position of the electrode terminal BCa deviates within a range of design tolerance due to thermal expansion or thermal contraction of the battery cell BC during use of the battery module BM, the bus bar can follow the deviation of the inter-cell pitch within the range of design tolerance due to thermal expansion or thermal contraction of the battery cell BC or the deviation of the position of the electrode terminal BCa within the range of design tolerance due to thermal expansion or thermal contraction of the battery cell BC by absorbing the deviation of the inter-terminal pitch or the deviation of the position of the electrode terminal BCa with the spring portion.

In the bus bar of the present embodiment, the spring portion (tolerance absorbing structure) is provided at a location avoiding a central portion between the first terminal connecting body and the second terminal connecting body, so that the central portion can have a heat resistant structure without being restricted by the tolerance absorbing structure. Furthermore, since the bus bar of the present embodiment is provided with the spring portion (tolerance absorbing structure) at a welded portion with the electrode terminal BCa having the highest temperature reduction effect by thermal dissipation of the battery cell BC, heat generation of the bus bar itself can be suppressed, and the heat resistant structure (that is, a cross-sectional area of the central portion) can be downsized.

Hereinafter, specific examples of the bus bar of the present embodiment will be described.

### First Specific Example

Reference Numeral 1 in FIG. 1 indicates a bus bar of a first specific example in the present embodiment. The bus bar 1 includes a bus bar body 10 formed in a rectangular flat plate shape using a conductive material such as metal (FIG. 1). Then, the bus bar body 10 is divided into two parts including a first terminal connecting body 11 whose welding target is the first electrode terminal BCa of one battery cell BC and a second terminal connecting body 12 whose welding target is the second electrode terminal BCa of the other battery cell BC (FIG. 1).

In the bus bar body 10, a through-hole 13 and a flexible portion 14 are provided in the first terminal connecting body 11 having a rectangular flat plate shape, the flexible portion 14 is welded to the first electrode terminal BCa of one battery cell BC by laser welding or the like, and the second terminal connecting body 12 having a rectangular flat plate shape is welded to the second electrode terminal BCa of the other battery cell BC by laser welding or the like in the same manner as in the related art. Therefore, the through-hole 13 is made to overlap the first electrode terminal BCa to expose the first electrode terminal BCa. The through-hole 13 is formed in a circular shape or quadrangular shape larger than the first electrode terminal BCa and exposes the entire plane (welding surface) of the first electrode terminal BCa. The through-hole 13 illustrated here is formed in a circular shape. The second terminal connecting body 12 may be provided with a through-hole for welding.

The flexible portion 14 includes a terminal welded portion 14a that is welded to the first electrode terminal BCa exposed from the through-hole 13, and a spring portion 14b that is provided between the terminal welded portion 14a and a fixed end on an outer peripheral edge portion side of the through-hole 13 and is elastically deformable in a protruding direction of the spring portion 14b and an opposite direction thereto (FIGS. 1 and 2).

The flexible portion 14 is formed in a cantilever shape protruding from an outer peripheral edge portion of the through-hole 13 toward the hole center in a direction orthogonal to the arrangement direction of the plurality of battery cells BC (FIGS. 1 and 2). The terminal welded portion 14a is provided at a free end of the flexible portion 14 (FIGS. 1 and 2).

The flexible portion 14 is formed by bending a rectangular flat-plate-like piece. The flexible portion 14 illustrated here includes a flat-plate-like spring portion (hereinafter, referred to as "second spring portion") 14c protruding from the outer peripheral edge portion of the through-hole 13 toward the hole center in the direction orthogonal to the arrangement direction of the plurality of battery cells BC (FIGS. 1 and 2). The second spring portion 14c is deformed by being bent in a direction orthogonal to a plane of the first terminal connecting body 11 (the plane of the first electrode terminal BCa). The spring portion (hereinafter, referred to as "first spring portion") 14b illustrated here is formed in a V shape or a U shape rising toward a side opposite to the first electrode terminal BCa at a protruding end of the second spring portion 14c and folded back toward the first electrode terminal BCa at a tip of the rising portion (FIGS. 1 and 2). The first spring portion 14b is deformed by being bent in the direction orthogonal to the arrangement direction of the plurality of battery cells BC. The terminal welded portion 14a protrudes toward the hole center of the through-hole 13 in the direction orthogonal to the arrangement direction of the plurality of battery cells BC at a tip of the first spring portion 14b that is folded back toward the first electrode terminal BCa (FIGS. 1 and 2). The terminal welded portion 14a illustrated here is formed in a rectangular flat plate shape parallel to the plane (welded surface) of the first electrode terminal BCa.

In the first terminal connecting body 11, a pair of flexible portions 14 is provided in opposite protruding directions (FIGS. 1 and 2). The pair of flexible portions 14 is arranged in the direction orthogonal to the arrangement direction of the plurality of battery cells BC.

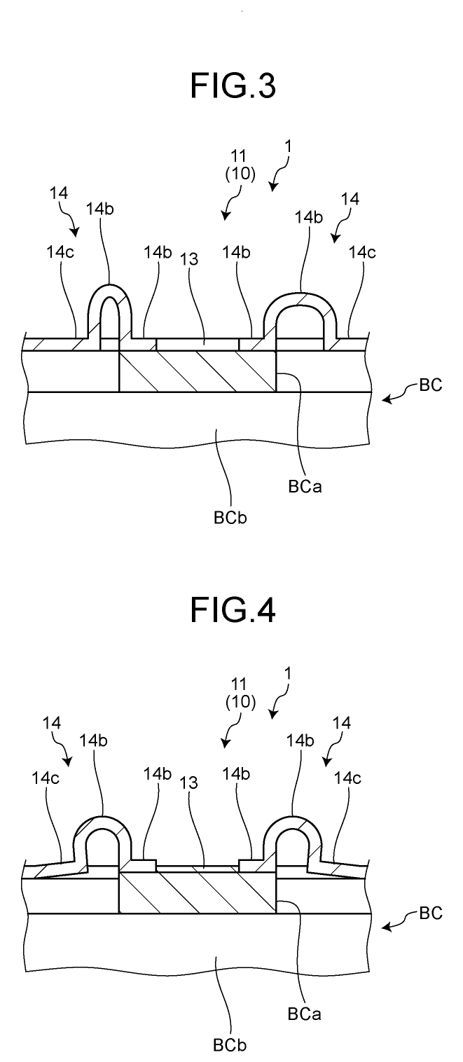

Even in a case where a position of the first electrode terminal BCa or the second electrode terminal BCa deviates within a range of design tolerance due to thermal expansion or thermal contraction of one battery cell BC or the other battery cell BC during use of the battery module BM, the bus bar 1 of the first specific example can follow the deviation of the position of the electrode terminal BCa within the range of design tolerance due to the thermal expansion or thermal contraction of one battery cell BC or the other battery cell BC by absorbing the deviation of the position of the electrode terminal BCa with the first spring portion 14b or the second spring portion 14c. FIG. 3 illustrates an example of followability of the flexible portion 14 when the position of the electrode terminal BCa deviates in the direction orthogonal to the arrangement direction of the plurality of battery cells BC. FIG. 4 illustrates an example of followability of the flexible portion 14 when the position of the electrode terminal BCa deviates in a direction orthogonal to the plane of the first terminal connecting body 11 (the plane of the first electrode terminal BCa).

In addition, in the bus bar 1 of the first specific example, the bus bar body 10 is formed in a flat plate shape, and then, the first spring portion 14b and the second spring portion 14c that serve as the tolerance absorbing structure are provided in the first terminal connecting body 11 at a position avoiding a central portion of the bus bar body 10. Therefore, the bus bar 1 can connect the first electrode terminal BCa and the second electrode terminal BCa with the shortest possible energization path, and thus, a resistance value or a heat generation amount can be minimized. Furthermore, since the bus bar 1 of the first specific example is provided with the tolerance absorbing structure (the first spring portion 14b and the second spring portion 14c) at a welded portion with the electrode terminal BCa having the highest temperature reduction effect by heat dissipation of the battery cell BC, heat generation of the bus bar 1 itself can be suppressed, and a heat resistant structure (that is, a cross-sectional area of the central portion of the bus bar body 10) can be downsized.

In the bus bar 1 of the first specific example, the second spring portion 14c does not have to be provided, and in this case, the first spring portion 14b may function as the second spring portion 14c to absorb the deviation of the position of the electrode terminal BCa.

### Second Specific Example

Reference Numeral 2 in FIG. 5 indicates a bus bar of a second specific example in the present embodiment. The bus bar 2 includes a bus bar body 20 formed in a rectangular flat plate shape using a conductive material such as metal (FIG. 5). Then, the bus bar body 20 is divided into two parts including a first terminal connecting body 21 whose welding target is the first electrode terminal BCa of one battery cell BC and a second terminal connecting body 22 whose welding target is the second electrode terminal BCa of the other battery cell BC (FIG. 5).

In the bus bar body 20, a through-hole 23 and a flexible portion 24 are provided in the first terminal connecting body 21 having a rectangular flat plate shape, the flexible portion 24 is welded to the first electrode terminal BCa of one battery cell BC by laser welding or the like, and the second terminal connecting body 22 having a rectangular flat plate shape is welded to the second electrode terminal BCa of the other battery cell BC by laser welding or the like in the same manner as in the related art. Therefore, the through-hole 23 is made to overlap the first electrode terminal BCa to expose the first electrode terminal BCa. The through-hole 23 is formed in a circular shape or quadrangular shape larger than the first electrode terminal BCa and exposes the entire plane (welding surface) of the first electrode terminal BCa. The through-hole 23 illustrated here is formed in a circular shape. The second terminal connecting body 22 may be provided with a through-hole for welding.

The flexible portion 24 includes a terminal welded portion 24a that is welded to the first electrode terminal BCa exposed from the through-hole 23, and a spring portion 24b that is provided between the terminal welded portion 24a and a fixed end on an outer peripheral edge portion side of the through-hole 23 and is elastically deformable in a protruding direction of the spring portion 24b and an opposite direction thereto (FIG. 5).

The flexible portion 24 is formed in a cantilever shape protruding from an outer peripheral edge portion of the through-hole 23 toward the hole center in the arrangement direction of the plurality of battery cells BC (FIG. 5). The terminal welded portion 24a is provided at a free end of the flexible portion 24 (FIG. 5).

The flexible portion 24 is formed in the same shape as the flexible portion 14 of the first specific example. Therefore, the flexible portion 24 includes a flat-plate-like spring portion (hereinafter, referred to as "second spring portion") 24c protruding from the outer peripheral edge portion of the through-hole 23 toward the hole center in the arrangement direction of the plurality of battery cells BC (FIG. 5). The second spring portion 24c is deformed by being bent in a direction orthogonal to a plane of the first terminal connecting body 21 (the plane of the first electrode terminal BCa). The spring portion (hereinafter, referred to as "first spring portion") 24b illustrated here is formed in a V shape or a U shape rising toward a side opposite to the first electrode terminal BCa at a protruding end of the second spring portion 24c and folded back toward the first electrode terminal BCa at a tip of the rising portion (FIG. 5). The first spring portion 24b is deformed by being bent in the arrangement direction of the plurality of battery cells BC. The terminal welded portion 24a protrudes toward the hole center of the through-hole 23 in the arrangement direction of the plurality of battery cells BC at a tip of the first spring portion 24b that is folded back toward the first electrode terminal BCa (FIG. 5). The terminal welded portion 24a illustrated here is formed in a rectangular flat plate shape parallel to the plane (welded surface) of the first electrode terminal BCa.

In the first terminal connecting body 21, a pair of flexible portions 24 is provided in opposite protruding directions (FIG. 5). The pair of flexible portions 24 is arranged in the arrangement direction of the plurality of battery cells BC.

Even in a case where a position of the first electrode terminal BCa or the second electrode terminal BCa deviates within a range of design tolerance due to thermal expansion or thermal contraction of one battery cell BC or the other battery cell BC during use of the battery module BM, the bus bar 2 of the second specific example can follow the deviation of the position of the electrode terminal BCa within the range of design tolerance due to the thermal expansion or thermal contraction of one battery cell BC or the other battery cell BC by absorbing the deviation of the position of the electrode terminal BCa with the first spring portion 24b or the second spring portion 24c. Furthermore, even in a case where the inter-terminal pitch deviates within a range of design tolerance due to thermal expansion or thermal contraction of one battery cell BC or the other battery cell BC during use of the battery module BM, the bus bar 2 of the second specific example can follow the deviation of the inter-cell pitch within the range of design tolerance due to the thermal expansion or thermal contraction of one battery cell BC or the other battery cell BC by absorbing the deviation of the inter-terminal pitch with the first spring portion 24b.

In addition, in the bus bar 2 of the second specific example, the bus bar body 20 is formed in a flat plate shape, and then, the first spring portion 24b and the second spring portion 24c that serve as the tolerance absorbing structure are provided in the first terminal connecting body 21 at a position avoiding a central portion of the bus bar body 20. Therefore, the bus bar 2 can connect the first electrode terminal BCa and the second electrode terminal BCa with the shortest possible energization path, and thus, a resistance value or a heat generation amount can be minimized. Furthermore, since the bus bar 2 of the second specific example is provided with the tolerance absorbing structure (the first spring portion 24b and the second spring portion 24c) at a welded portion with the electrode terminal BCa having the highest temperature reduction effect by heat dissipation of the battery cell BC, heat generation of the bus bar 2 itself can be suppressed, and a heat resistant structure (that is, a cross-sectional area of the central portion of the bus bar body 20) can be downsized.

In the bus bar 2 of the second specific example, the second spring portion 24c does not have to be provided, and in this case, the first spring portion 24b may function as the second spring portion 24c to absorb the deviation of the position of the electrode terminal BCa.

### Third Specific Example

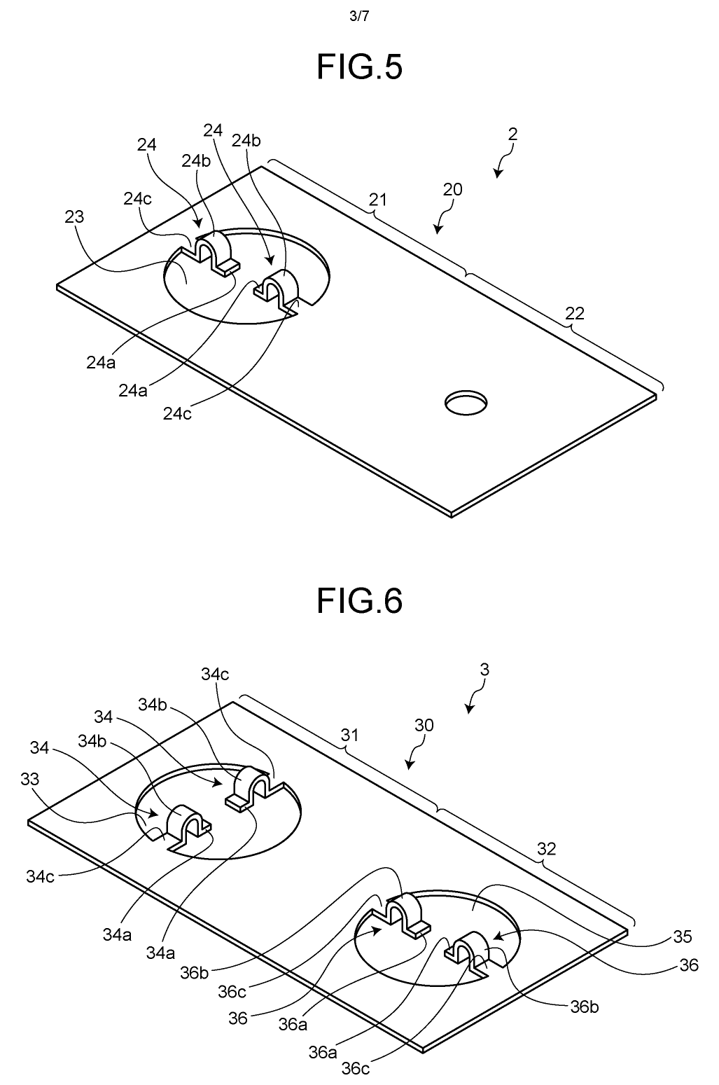

Reference Numeral 3 in FIG. 6 indicates a bus bar of a third specific example in the present embodiment. The bus bar 3 includes a bus bar body 30 formed in a rectangular flat plate shape using a conductive material such as metal (FIG. 6). Then, the bus bar body 30 is divided into two parts including a first terminal connecting body 31 whose welding target is the first electrode terminal BCa of one battery cell BC and a second terminal connecting body 32 whose welding target is the second electrode terminal BCa of the other battery cell BC (FIG. 6).

In the bus bar body 30, a through-hole (hereinafter, referred to as "first through-hole") 33 and a flexible portion (hereinafter, referred to as "first flexible portion") 34 are provided in the first terminal connecting body 31 having a rectangular flat plate shape, the first flexible portion 34 is welded to the first electrode terminal BCa of one battery cell BC by laser welding or the like, a through-hole (hereinafter, referred to as "second through-hole") 35 and a flexible portion (hereinafter, referred to as "second flexible portion") 36 are provided in the second terminal connecting body 32 having a rectangular flat plate shape, and the second flexible portion 36 is welded to the second electrode terminal BCa of the other battery cell BC by laser welding or the like (FIG. 6).

The first through-hole 33 is made to overlap the first electrode terminal BCa to expose the first electrode terminal BCa. The first through-hole 33 is formed in a circular shape or quadrangular shape larger than the first electrode terminal BCa and exposes the entire plane (welding surface) of the first electrode terminal BCa. Further, the second through-hole 35 is made to overlap the second electrode terminal BCa to expose the second electrode terminal BCa. The second through-hole 35 is formed in a circular shape or quadrangular shape larger than the second electrode terminal BCa and exposes the entire plane (welding surface) of the second electrode terminal BCa. The first through-hole 33 and the second through-hole 35 illustrated here are formed in a circular shape.

The first flexible portion 34 includes a terminal welded portion 34a that is welded to the first electrode terminal BCa exposed from the first through-hole 33, and a spring portion 34b that is provided between the terminal welded portion 34a and a fixed end on an outer peripheral edge portion side of the first through-hole 33 and is elastically deformable in a protruding direction of the spring portion 34b and in an opposite direction thereto (FIG. 6).

The first flexible portion 34 is formed in a cantilever shape protruding from an outer peripheral edge portion of the first through-hole 33 toward the hole center in the direction orthogonal to the arrangement direction of the plurality of battery cells BC (FIG. 6). Then, the terminal welded portion 34a is provided at a free end of the first flexible portion 34 and is welded to the first electrode terminal BCa (FIG. 6).

The first flexible portion 34 is formed in the same shape as the flexible portion 14 of the first specific example, and is arranged at the same location as the flexible portion 14 of the first specific example. Therefore, the first flexible portion 34 includes a flat-plate-like spring portion (hereinafter, referred to as "second spring portion") 34c protruding from the outer peripheral edge portion of the first through-hole 33 toward the hole center in the direction orthogonal to the arrangement direction of the plurality of battery cells BC (FIG. 6). The second spring portion 34c is deformed by being bent in a direction orthogonal to a plane of the first terminal connecting body 31 (the plane of the first electrode terminal BCa). The spring portion (hereinafter, referred to as "first spring portion") 34b illustrated here is formed in a V shape or a U shape rising toward a side opposite to the first electrode terminal BCa at a protruding end of the second spring portion 34c and folded back toward the first electrode terminal BCa at a tip of the rising portion (FIG. 6). The first spring portion 34b is deformed by being bent in the direction orthogonal to the arrangement direction of the plurality of battery cells BC. The terminal welded portion 34a protrudes toward the hole center of the first through-hole 33 in the direction orthogonal to the arrangement direction of the plurality of battery cells BC at a tip of the first spring portion 34b that is folded back toward the first electrode terminal BCa (FIG. 6). The terminal welded portion 34a illustrated here is formed in a rectangular flat plate shape parallel to the plane (welded surface) of the first electrode terminal BCa.

In the first terminal connecting body 31, a pair of first flexible portions 34 is provided in opposite protruding directions (FIG. 6). The pair of first flexible portions 34 is arranged in the direction orthogonal to the arrangement direction of the plurality of battery cells BC.

The second flexible portion 36 includes a terminal welded portion 36a that is welded to the second electrode terminal BCa exposed from the second through-hole 35, and a spring portion 36b that is provided between the terminal welded portion 36a and a fixed end on an outer peripheral edge portion side of the second through-hole 35 and is elastically deformable in a protruding direction of the spring portion 36b and in an opposite direction thereto (FIG. 6).

The second flexible portion 36 is formed in a cantilever shape protruding from an outer peripheral edge portion of the second through-hole 35 toward the hole center in the arrangement direction of the plurality of battery cells BC (FIG. 6). Then, the terminal welded portion 36a is provided at a free end of the second flexible portion 36 and is welded to the second electrode terminal BCa (FIG. 6).

The second flexible portion 36 is formed in the same shape as the flexible portion 24 of the second specific example, and is arranged at the same location as the flexible portion 24 of the second specific example. Therefore, the second flexible portion 36 includes a flat-plate-like spring portion (hereinafter, referred to as "second spring portion") 36c protruding from the outer peripheral edge portion of the second through-hole 35 toward the hole center in the arrangement direction of the plurality of battery cells BC (FIG. 6). The second spring portion 36c is deformed by being bent in a direction orthogonal to a plane of the second terminal connecting body 32 (a plane of the second electrode terminal BCa). The spring portion (hereinafter, referred to as "first spring portion") 36b illustrated here is formed in a V shape or a U shape rising toward a side opposite to the second electrode terminal BCa at a protruding end of the second spring portion 36c and folded back toward the second electrode terminal BCa at a tip of the rising portion (FIG. 6). The first spring portion 36b is deformed by being bent in the arrangement direction of the plurality of battery cells BC. The terminal welded portion 36a protrudes toward the hole center of the second through-hole 35 in the arrangement direction of the plurality of battery cells BC at a tip of the first spring portion 36b that is folded back toward the second electrode terminal BCa (FIG. 6). The terminal welded portion 36a illustrated here is formed in a rectangular flat plate shape parallel to the plane (welded surface) of the second electrode terminal BCa.

In the second terminal connecting body 32, a pair of second flexible portions 36 is provided in opposite protruding directions (FIG. 6). The pair of second flexible portions 36 is arranged in the arrangement direction of the plurality of battery cells BC.

Even in a case where a position of the first electrode terminal BCa deviates within a range of design tolerance due to thermal expansion or thermal contraction of one battery cell BC during use of the battery module BM, the bus bar 3 of the third specific example can follow the deviation of the position of the first electrode terminal BCa within the range of design tolerance due to the thermal expansion or thermal contraction of one battery cell BC by absorbing the deviation of the position of the first electrode terminal BCa with the first spring portion 34b or the second spring portion 34c of the first flexible portion 34. Further, even in a case where a position of the second electrode terminal BCa deviates within a range of design tolerance due to thermal expansion or thermal contraction of the other battery cell BC during use of the battery module BM, the bus bar 3 of the third specific example can follow the deviation of the position of the second electrode terminal BCa within the range of design tolerance due to the thermal expansion or thermal contraction of the other battery cell BC by absorbing the deviation of the position of the second electrode terminal BCa with the first spring portion 36b or the second spring portion 36c of the second flexible portion 36.

Furthermore, even in a case where the inter-terminal pitch deviates within a range of design tolerance due to thermal expansion or thermal contraction of one battery cell BC or the other battery cell BC during use of the battery module BM, the bus bar 3 of the third specific example can follow the deviation of the inter-cell pitch within the range of design tolerance due to the thermal expansion or thermal contraction of one battery cell BC or the other battery cell BC by absorbing the deviation of the inter-terminal pitch with the first spring portion 36b of the second flexible portion 36.

Further, in the bus bar 3 of the third specific example, the bus bar body 30 is formed in a flat plate shape, and then the first spring portion 34b and the second spring portion 34c of the first flexible portion 34 that serve as the tolerance absorbing structure are provided in the first terminal connecting body 31 at a position avoiding a central portion of the bus bar body 30, and the first spring portion 36b and the second spring portion 36c of the second flexible portion 36 that serve as the tolerance absorbing structure are provided in the second terminal connecting body 32 at a position avoiding the central portion of the bus bar body 30. Therefore, the bus bar 3 can connect the first electrode terminal BCa and the second electrode terminal BCa with the shortest possible energization path, and thus, a resistance value or a heat generation amount can be minimized. Further, since the bus bar 3 of the third specific example is provided with the tolerance absorbing structures (the first spring portion 34b and the second spring portion 34c of the first flexible portion 34, and the first spring portion 36b and the second spring portion 36c of the second flexible portion 36) at welded portions with the electrode terminals BCa having the highest temperature reduction effect by heat dissipation of the battery cell BC, heat generation of the bus bar 3 itself can be suppressed, and a heat resistant structure (that is, a cross-sectional area of the central portion of the bus bar body 30) can be downsized.

In the bus bar 3 of the third specific example, the second spring portions 34c and 36c do not have to be provided, and in this case, the first spring portions 34b and 36b may function as the second spring portions 34c and 36c to absorb the deviations of the positions of the electrode terminals BCa.

### Fourth Specific Example

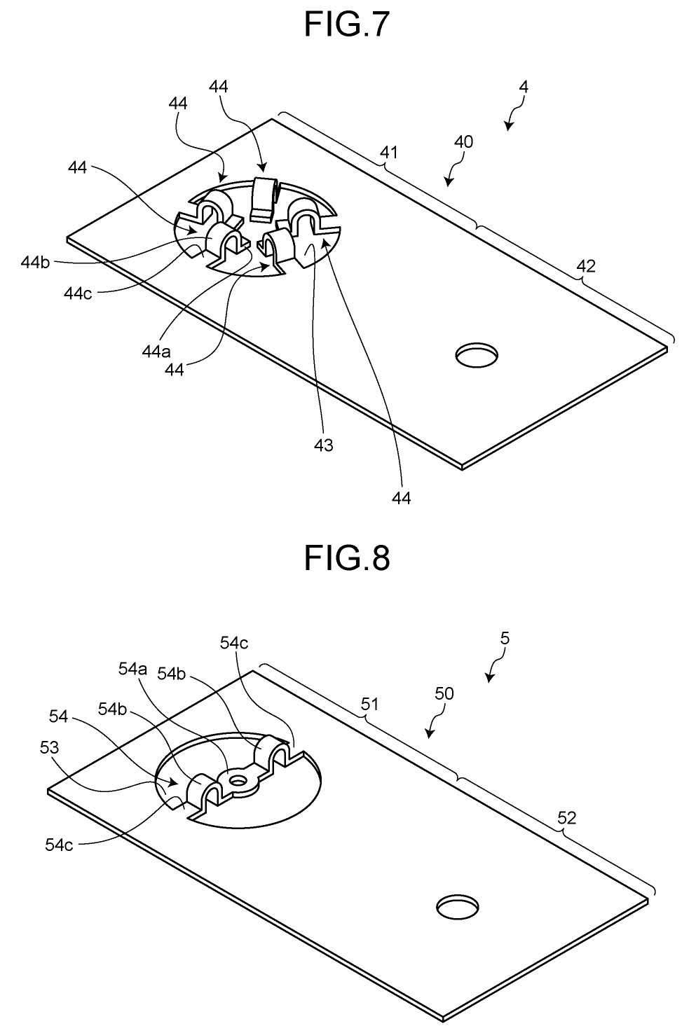

Reference Numeral 4 in FIG. 7 indicates a bus bar of a fourth specific example in the present embodiment. The bus bar 4 includes a bus bar body 40 formed in a rectangular flat plate shape using a conductive material such as metal (FIG. 7). Then, the bus bar body 40 is divided into two parts including a first terminal connecting body 41 whose welding target is the first electrode terminal BCa of one battery cell BC and a second terminal connecting body 42 whose welding target is the second electrode terminal BCa of the other battery cell BC (FIG. 7).

In the bus bar body 40, a through-hole 43 and a flexible portion 44 are provided in the first terminal connecting body 41 having a rectangular flat plate shape, the flexible portion 44 is welded to the first electrode terminal BCa of one battery cell BC by laser welding or the like, and the second terminal connecting body 42 having a rectangular flat plate shape is welded to the second electrode terminal BCa of the other battery cell BC by laser welding or the like in the same manner as in the related art. Therefore, the through-hole 43 is made to overlap the first electrode terminal BCa to expose the first electrode terminal BCa. The through-hole 43 is formed in a circular shape larger than the first electrode terminal BCa and exposes the entire plane (welding surface) of the first electrode terminal BCa. The second terminal connecting body 42 may be provided with a through-hole for welding. Further, a through-hole 43 and a flexible portion 44 similar to those of the first terminal connecting body 41 may be provided in the second terminal connecting body 42.

The flexible portion 44 includes a terminal welded portion 44a that is welded to the first electrode terminal BCa exposed from the through-hole 43, and a spring portion 44b that is provided between the terminal welded portion 44a and a fixed end on an outer peripheral edge portion side of the through-hole 43 and is elastically deformable in a protruding direction of the spring portion 44b and an opposite direction thereto (FIG. 7).

The flexible portion 44 is formed in a cantilever shape protruding from an outer peripheral edge portion of the through-hole 43 toward the hole center (FIG. 7). Then, a plurality of flexible portions 44 are provided at equal intervals over the entire circumference of the through-hole 43 (FIG. 7). The terminal welded portion 44a is provided at a free end of the flexible portion 44 (FIG. 7). For example, one of the plurality of flexible portions 44 is formed in a cantilever shape protruding from the outer peripheral edge portion of the through-hole 43 toward the hole center in the direction orthogonal to the arrangement direction of the plurality of battery cells BC. In the first terminal connecting body 41, the plurality of flexible portions 44 are provided at equal intervals over the entire circumference of the through-hole 43. Five flexible portions 44 are provided in the first terminal connecting body 41 illustrated here.

The flexible portion 44 is formed in the same shape as the flexible portion 14 of the first specific example and the flexible portion 24 of the second specific example. Therefore, the flexible portion 44 includes a flat-plate-like spring portion (hereinafter, referred to as "second spring portion") 44c protruding from the outer peripheral edge portion of the through-hole 43 toward the hole center (FIG. 7). The second spring portion 44c is deformed by being bent in a direction orthogonal to a plane of the first terminal connecting body 41 (the plane of the first electrode terminal BCa). The spring portion (hereinafter, referred to as "first spring portion") 44b illustrated here is formed in a V shape or a U shape rising toward a side opposite to the first electrode terminal BCa at a protruding end of the second spring portion 44c and folded back toward the first electrode terminal BCa at a tip of the rising portion (FIG. 7). The first spring portion 44b is deformed by being bent in a direction opposite to a protruding direction of the flexible portion 44 from the outer peripheral edge portion of the through-hole 43. The terminal welded portion 44a protrudes toward the hole center of the through-hole 43 at a tip of the first spring portion 44b that is folded back toward the first electrode terminal BCa (FIG. 7). The terminal welded portion 44a illustrated here is formed in a rectangular flat plate shape parallel to the plane (welded surface) of the first electrode terminal BCa.

Even in a case where a position of the first electrode terminal BCa or the second electrode terminal BCa deviates within a range of design tolerance due to thermal expansion or thermal contraction of one battery cell BC or the other battery cell BC during use of the battery module BM, the bus bar 4 of the fourth specific example can follow the deviation of the position of the electrode terminal BCa within the range of design tolerance due to the thermal expansion or thermal contraction of one battery cell BC or the other battery cell BC by absorbing the deviation of the position of the electrode terminal BCa with the first spring portion 44b or the second spring portion 44c of each flexible portion 44. Furthermore, even in a case where the inter-terminal pitch deviates within a range of design tolerance due to thermal expansion or thermal contraction of one battery cell BC or the other battery cell BC during use of the battery module BM, the bus bar 4 of the fourth specific example can follow the deviation of the inter-cell pitch within the range of design tolerance due to the thermal expansion or thermal contraction of one battery cell BC or the other battery cell BC by absorbing the deviation of the inter-terminal pitch with the first spring portion 44b of each flexible portion 44.

In addition, in the bus bar 4 of the fourth specific example, the bus bar body 40 is formed in a flat plate shape, and then, the first spring portion 44b and the second spring portion 44c of each flexible portion 44 that serve as the tolerance absorbing structure are provided in the first terminal connecting body 41 at a position avoiding a central portion of the bus bar body 40. Therefore, the bus bar 4 can connect the first electrode terminal BCa and the second electrode terminal BCa with the shortest possible energization path, and thus, a resistance value or a heat generation amount can be minimized. Furthermore, since the bus bar 4 of the fourth specific example is provided with the tolerance absorbing structure (the first spring portion 44b and the second spring portion 44c of each flexible portion 44) at a welded portion with the electrode terminal BCa having the highest temperature reduction effect by heat dissipation of the battery cell BC, heat generation of the bus bar 4 itself can be suppressed, and a heat resistant structure (that is, a cross-sectional area of the central portion of the bus bar body 40) can be downsized.

In the bus bar 4 of the fourth specific example, the second spring portion 44c does not have to be provided, and in this case, the first spring portion 44b may function as the second spring portion 44c to absorb the deviation of the position of the electrode terminal BCa.

### Fifth Specific Example

Reference Numeral 5 in FIG. 8 indicates a bus bar of a fifth specific example in the present embodiment. The bus bar 5 includes a bus bar body 50 formed in a rectangular flat plate shape using a conductive material such as metal (FIG. 8). Then, the bus bar body 50 is divided into two parts including a first terminal connecting body 51 whose welding target is the first electrode terminal BCa of one battery cell BC and a second terminal connecting body 52 whose welding target is the second electrode terminal BCa of the other battery cell BC (FIG. 8).

In the bus bar body 50, a through-hole 53 and a flexible portion 54 are provided in the first terminal connecting body 51 having a rectangular flat plate shape, the flexible portion 54 is welded to the first electrode terminal BCa of one battery cell BC by laser welding or the like, and the second terminal connecting body 52 having a rectangular flat plate shape is welded to the second electrode terminal BCa of the other battery cell BC by laser welding or the like in the same manner as in the related art. Therefore, the through-hole 53 is made to overlap the first electrode terminal BCa to expose the first electrode terminal BCa. The through-hole 53 is formed in a circular shape or quadrangular shape larger than the first electrode terminal BCa and exposes the entire plane (welding surface) of the first electrode terminal BCa. The through-hole 53 illustrated here is formed in a circular shape. The second terminal connecting body 52 may be provided with a through-hole for welding.

The flexible portion 54 includes a terminal welded portion 54a that is welded to the first electrode terminal BCa exposed from the through-hole 53, and a spring portion 54b that is provided between the terminal welded portion 54a and a fixed end on an outer peripheral edge portion side of the through-hole 53 and is elastically deformable in a protruding direction of the spring portion 54b and an opposite direction thereto (FIG. 8).

The flexible portion 54 is formed in a double-supported beam shape protruding from two positions facing each other on an outer peripheral edge portion of the through-hole 53 toward the hole center in the direction orthogonal to the arrangement direction of the plurality of battery cells BC (FIG. 8). The terminal welded portion 54a is arranged at the center of the flexible portion 54 and at the hole center of the through-hole 53 (FIG. 8). The spring portion 54b is provided at each of a position between the terminal welded portion 54a and one fixed end and a position between the terminal welded portion 54a and the other fixed end (FIG. 8).

The flexible portion 54 includes a flat-plate-like spring portion (hereinafter, referred to as "second spring portion") 54c protruding from each of two positions facing each other on the outer peripheral edge portion of the through-hole 53 toward the hole center in the direction orthogonal to the arrangement direction of the plurality of battery cells BC (FIG. 8). Each second spring portion 54c is deformed by being bent in a direction orthogonal to a plane of the first terminal connecting body 51 (the plane of the first electrode terminal BCa). The spring portion (hereinafter, referred to as "first spring portion") 54b illustrated here is formed in a V shape or a U shape rising toward a side opposite to the first electrode terminal BCa at a protruding end of the second spring portion 54c and folded back toward the first electrode terminal BCa at a tip of the rising portion (FIG. 8). Each first spring portion 54b is deformed by being bent in the direction orthogonal to the arrangement direction of the plurality of battery cells BC. In addition, the terminal welded portion 54a connects between end portions of tips of the respective first spring portions 54b that are folded back toward the first electrode terminal BCa (FIG. 8). The terminal welded portion 54a illustrated here is formed in a disk shape parallel to the plane (welded surface) of the first electrode terminal BCa.

Even in a case where a position of the first electrode terminal BCa or the second electrode terminal BCa deviates within a range of design tolerance due to thermal expansion or thermal contraction of one battery cell BC or the other battery cell BC during use of the battery module BM, the bus bar 5 of the fifth specific example can follow the deviation of the position of the electrode terminal BCa within the range of design tolerance due to the thermal expansion or thermal contraction of one battery cell BC or the other battery cell BC by absorbing the deviation of the position of the electrode terminal BCa with a pair of first spring portion 54b or a pair of second spring portion 54c.

In addition, in the bus bar 5 of the fifth specific example, the bus bar body 50 is formed in a flat plate shape, and then, the first spring portion 54b and the second spring portion 54c that serve as the tolerance absorbing structure are provided in the first terminal connecting body 51 at a position avoiding a central portion of the bus bar body 50. Therefore, the bus bar 5 can connect the first electrode terminal BCa and the second electrode terminal BCa with the shortest possible energization path, and thus, a resistance value or a heat generation amount can be minimized. Furthermore, since the bus bar 5 of the fifth specific example is provided with the tolerance absorbing structure (the first spring portion 54b and the second spring portion 54c) at a welded portion with the electrode terminal BCa having the highest temperature reduction effect by heat dissipation of the battery cell BC, heat generation of the bus bar 5 itself can be suppressed, and a heat resistant structure (that is, a cross-sectional area of the central portion of the bus bar body 50) can be downsized.

In the bus bar 5 of the fifth specific example, the second spring portion 54c does not have to be provided, and in this case, the first spring portion 54b may function as the second spring portion 54c to absorb the deviation of the position of the electrode terminal BCa.

### Sixth Specific Example

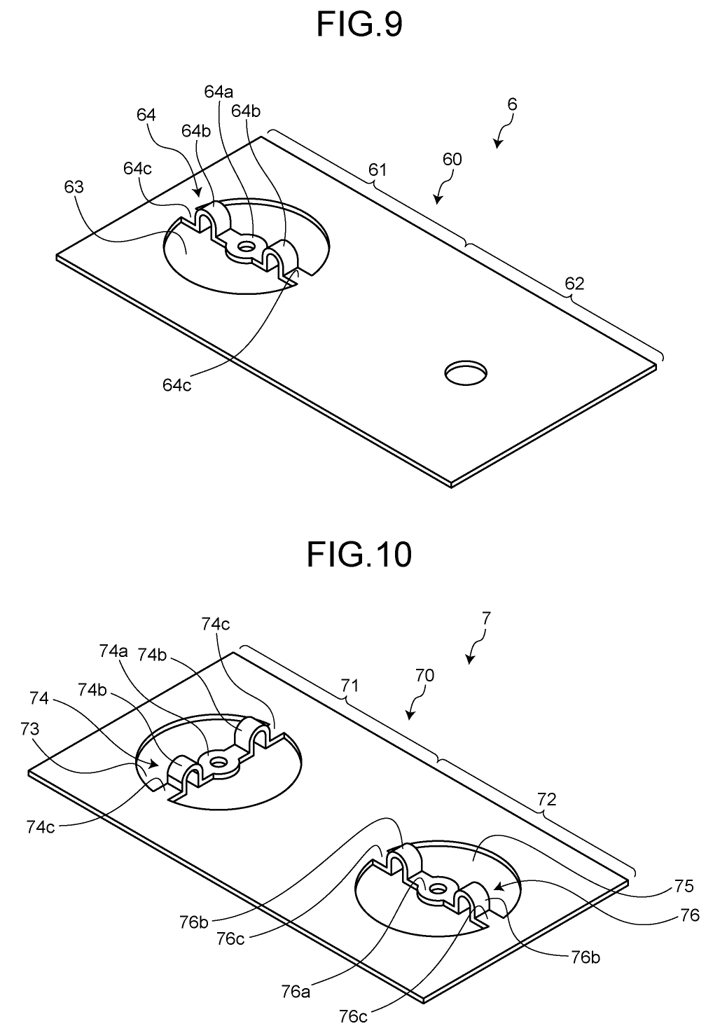

Reference Numeral 6 in FIG. 9 indicates a bus bar of a sixth specific example in the present embodiment. The bus bar 6 includes a bus bar body 60 formed in a rectangular flat plate shape using a conductive material such as metal (FIG. 9). Then, the bus bar body 60 is divided into two parts including a first terminal connecting body 61 whose welding target is the first electrode terminal BCa of one battery cell BC and a second terminal connecting body 62 whose welding target is the second electrode terminal BCa of the other battery cell BC (FIG. 9).

In the bus bar body 60, a through-hole 63 and a flexible portion 64 are provided in the first terminal connecting body 61 having a rectangular flat plate shape, the flexible portion 64 is welded to the first electrode terminal BCa of one battery cell BC by laser welding or the like, and the second terminal connecting body 62 having a rectangular flat plate shape is welded to the second electrode terminal BCa of the other battery cell BC by laser welding or the like in the same manner as in the related art. Therefore, the through-hole 63 is made to overlap the first electrode terminal BCa to expose the first electrode terminal BCa. The through-hole 63 is formed in a circular shape or quadrangular shape larger than the first electrode terminal BCa and exposes the entire plane (welding surface) of the first electrode terminal BCa. The through-hole 63 illustrated here is formed in a circular shape. The second terminal connecting body 62 may be provided with a through-hole for welding.

The flexible portion 64 includes a terminal welded portion 64a that is welded to the first electrode terminal BCa exposed from the through-hole 63, and a spring portion 64b that is provided between the terminal welded portion 64a and a fixed end on an outer peripheral edge portion side of the through-hole 63 and is elastically deformable in a protruding direction of the spring portion 64b and an opposite direction thereto (FIG. 9).

The flexible portion 64 is formed in a double-supported beam shape protruding from two positions facing each other on an outer peripheral edge portion of the through-hole 63 toward the hole center in the arrangement direction of the plurality of battery cells BC (FIG. 9). The terminal welded portion 64a is arranged at the center of the flexible portion 64 and at the hole center of the through-hole 63 (FIG. 9). The spring portion 64b is provided at each of a position between the terminal welded portion 64a and one fixed end and a position between the terminal welded portion 64a and the other fixed end (FIG. 9).

The flexible portion 64 is formed in the same shape as the flexible portion 54 of the fifth specific example. Therefore, the flexible portion 64 includes a flat-plate-like spring portion (hereinafter, referred to as "second spring portion") 64c protruding from each of two positions facing each other on the outer peripheral edge portion of the through-hole 63 toward the hole center in the arrangement direction of the plurality of battery cells BC (FIG. 9). Each second spring portion 64c is deformed by being bent in a direction orthogonal to a plane of the first terminal connecting body 61 (the plane of the first electrode terminal BCa). The spring portion (hereinafter, referred to as "first spring portion") 64b illustrated here is formed in a V shape or a U shape rising toward a side opposite to the first electrode terminal BCa at a protruding end of the second spring portion 64c and folded back toward the first electrode terminal BCa at a tip of the rising portion (FIG. 9). Each first spring portion 64b is deformed by being bent in the arrangement direction of the plurality of battery cells BC. In addition, the terminal welded portion 64a connects between end portions of tips of the respective first spring portions 64b that are folded back toward the first electrode terminal BCa (FIG. 9). The terminal welded portion 64a illustrated here is formed in a disk shape parallel to the plane (welded surface) of the first electrode terminal BCa.

Even in a case where a position of the first electrode terminal BCa or the second electrode terminal BCa deviates within a range of design tolerance due to thermal expansion or thermal contraction of one battery cell BC or the other battery cell BC during use of the battery module BM, the bus bar 6 of the sixth specific example can follow the deviation of the position of the electrode terminal BCa within the range of design tolerance due to the thermal expansion or thermal contraction of one battery cell BC or the other battery cell BC by absorbing the deviation of the position of the electrode terminal BCa with a pair of first spring portion 64b or a pair of second spring portion 64c. Furthermore, even in a case where the inter-terminal pitch deviates within a range of design tolerance due to thermal expansion or thermal contraction of one battery cell BC or the other battery cell BC during use of the battery module BM, the bus bar 6 of the sixth specific example can follow the deviation of the inter-cell pitch within the range of design tolerance due to the thermal expansion or thermal contraction of one battery cell BC or the other battery cell BC by absorbing the deviation of the inter-terminal pitch with a pair of first spring portion 64b.

In addition, in the bus bar 6 of the sixth specific example, the bus bar body 60 is formed in a flat plate shape, and then, the first spring portion 64b and the second spring portion 64c that serve as the tolerance absorbing structure are provided in the first terminal connecting body 61 at a position avoiding a central portion of the bus bar body 60. Therefore, the bus bar 6 can connect the first electrode terminal BCa and the second electrode terminal BCa with the shortest possible energization path, and thus, a resistance value or a heat generation amount can be minimized. Furthermore, since the bus bar 6 of the sixth specific example is provided with the tolerance absorbing structure (the first spring portion 64b and the second spring portion 64c) at a welded portion with the electrode terminal BCa having the highest temperature reduction effect by heat dissipation of the battery cell BC, heat generation of the bus bar 6 itself can be suppressed, and a heat resistant structure (that is, a cross-sectional area of the central portion of the bus bar body 60) can be downsized.

In the bus bar 6 of the sixth specific example, the second spring portion 64c does not have to be provided, and in this case, the first spring portion 64b may function as the second spring portion 64c to absorb the deviation of the position of the electrode terminal BCa.

### Seventh Specific Example

Reference Numeral 7 in FIG. 10 indicates a bus bar of a seventh specific example in the present embodiment. The bus bar 7 includes a bus bar body 70 formed in a rectangular flat plate shape using a conductive material such as metal (FIG. 10). Then, the bus bar body 70 is divided into two parts including a first terminal connecting body 71 whose welding target is the first electrode terminal BCa of one battery cell BC and a second terminal connecting body 72 whose welding target is the second electrode terminal BCa of the other battery cell BC (FIG. 10).

In the bus bar body 70, a through-hole (hereinafter, referred to as "first through-hole") 73 and a flexible portion (hereinafter, referred to as "first flexible portion") 74 are provided in the first terminal connecting body 71 having a rectangular flat plate shape, the first flexible portion 74 is welded to the first electrode terminal BCa of one battery cell BC by laser welding or the like, a through-hole (hereinafter, referred to as "second through-hole") 75 and a flexible portion (hereinafter, referred to as "second flexible portion") 76 are provided in the second terminal connecting body 72 having a rectangular flat plate shape, and the second flexible portion 76 is welded to the second electrode terminal BCa of the other battery cell BC by laser welding or the like (FIG. 10).

The first through-hole 73 is made to overlap the first electrode terminal BCa to expose the first electrode terminal BCa. The first through-hole 73 is formed in a circular shape or quadrangular shape larger than the first electrode terminal BCa and exposes the entire plane (welding surface) of the first electrode terminal BCa. Further, the second through-hole 75 is made to overlap the second electrode terminal BCa to expose the second electrode terminal BCa. The second through-hole 75 is formed in a circular shape or quadrangular shape larger than the second electrode terminal BCa and exposes the entire plane (welding surface) of the second electrode terminal BCa. The first through-hole 73 and the second through-hole 75 illustrated here are formed in a circular shape.

The first flexible portion 74 includes a terminal welded portion 74a that is welded to the first electrode terminal BCa exposed from the first through-hole 73, and a spring portion 74b that is provided between the terminal welded portion 74a and a fixed end on an outer peripheral edge portion side of the first through-hole 73 and is elastically deformable in a protruding direction of the spring portion 74b and in an opposite direction thereto (FIG. 10).

The first flexible portion 74 is formed in a double-supported beam shape protruding from two positions facing each other on an outer peripheral edge portion of the first through-hole 73 toward the hole center in the direction orthogonal to the arrangement direction of the plurality of battery cells BC (FIG. 10). The terminal welded portion 74a is arranged at the center of the first flexible portion 74 and at the hole center of the first through-hole 73, and is welded to the first electrode terminal BCa (FIG. 10). The spring portion 74b is provided at each of a position between the terminal welded portion 74a and one fixed end and a position between the terminal welded portion 74a and the other fixed end (FIG. 10).

The first flexible portion 74 is formed in the same shape as the flexible portion 54 of the fifth specific example, and is arranged at the same location as the flexible portion 54 of the fifth specific example. Therefore, the first flexible portion 74 includes a flat-plate-like spring portion (hereinafter, referred to as "second spring portion") 74c protruding from each of two positions facing each other on the outer peripheral edge portion of the first through-hole 73 toward the hole center in the direction orthogonal to the arrangement direction of the plurality of battery cells BC (FIG. 10). Each second spring portion 74c is deformed by being bent in a direction orthogonal to a plane of the first terminal connecting body 71 (the plane of the first electrode terminal BCa). The spring portion (hereinafter, referred to as "first spring portion") 74b illustrated here is formed in a V shape or a U shape rising toward a side opposite to the first electrode terminal BCa at a protruding end of the second spring portion 74c and folded back toward the first electrode terminal BCa at a tip of the rising portion (FIG. 10). Each first spring portion 74b is deformed by being bent in a direction orthogonal to the arrangement direction of the plurality of battery cells BC. In addition, the terminal welded portion 74a connects between end portions of tips of the respective first spring portions 74b that are folded back toward the first electrode terminal BCa (FIG. 10). The terminal welded portion 74a illustrated here is formed in a disk shape parallel to the plane (welded surface) of the first electrode terminal BCa.

The second flexible portion 76 includes a terminal welded portion 76a that is welded to the second electrode terminal BCa exposed from the second through-hole 75, and a spring portion 76b that is provided between the terminal welded portion 76a and a fixed end on an outer peripheral edge portion side of the second through-hole 75 and is elastically deformable in a protruding direction of the spring portion 76b and in an opposite direction thereto (FIG. 10).

The second flexible portion 76 is formed in a double-supported beam shape protruding from two positions facing each other on an outer peripheral edge portion of the second through-hole 75 toward the hole center in the arrangement direction of the plurality of battery cells BC (FIG. 10). The terminal welded portion 76a is arranged at the center of the second flexible portion 76 and at the hole center of the second through-hole 75, and is welded to the second electrode terminal BCa (FIG. 10). The spring portion 76b is provided at each of a position between the terminal welded portion 76a and one fixed end and a position between the terminal welded portion 76a and the other fixed end (FIG. 10).

The second flexible portion 76 is formed in the same shape as the flexible portion 64 of the sixth specific example, and is arranged at the same location as the flexible portion 64 of the sixth specific example. Therefore, the second flexible portion 76 includes a flat-plate-like spring portion (hereinafter, referred to as "second spring portion") 76c protruding from each of two positions facing each other on the outer peripheral edge portion of the second through-hole 75 toward the hole center in the arrangement direction of the plurality of battery cells BC (FIG. 10). Each second spring portion 76c is deformed by being bent in a direction orthogonal to a plane of the second terminal connecting body 72 (the plane of the second electrode terminal BCa). The spring portion (hereinafter, referred to as "first spring portion") 76b illustrated here is formed in a V shape or a U shape rising toward a side opposite to the second electrode terminal BCa at a protruding end of the second spring portion 76c and folded back toward the second electrode terminal BCa at a tip of the rising portion (FIG. 10). Each first spring portion 76b is deformed by being bent in the arrangement direction of the plurality of battery cells BC. In addition, the terminal welded portion 76a connects between end portions of tips of the respective first spring portions 76b that are folded back toward the second electrode terminal BCa (FIG. 10). The terminal welded portion 76a illustrated here is formed in a disk shape parallel to the plane (welded surface) of the second electrode terminal BCa.

Even in a case where a position of the first electrode terminal BCa deviates within a range of design tolerance due to thermal expansion or thermal contraction of one battery cell BC during use of the battery module BM, the bus bar 7 of the seventh specific example can follow the deviation of the position of the first electrode terminal BCa within the range of design tolerance due to the thermal expansion or thermal contraction of one battery cell BC by absorbing the deviation of the position of the first electrode terminal BCa with the first spring portion 74b or the second spring portion 74c of the first flexible portion 74. Further, even in a case where a position of the second electrode terminal BCa deviates within a range of design tolerance due to thermal expansion or thermal contraction of the other battery cell BC during use of the battery module BM, the bus bar 7 of the seventh specific example can follow the deviation of the position of the second electrode terminal BCa within the range of design tolerance due to the thermal expansion or thermal contraction of the other battery cell BC by absorbing the deviation of the position of the second electrode terminal BCa with the first spring portion 76b or the second spring portion 76c of the second flexible portion 76.

Furthermore, even in a case where the inter-terminal pitch deviates within a range of design tolerance due to thermal expansion or thermal contraction of one battery cell BC or the other battery cell BC during use of the battery module BM, the bus bar 7 of the seventh specific example can follow the deviation of the inter-cell pitch within the range of design tolerance due to the thermal expansion or thermal contraction of one battery cell BC or the other battery cell BC by absorbing the deviation of the inter-terminal pitch with the first spring portion 76b of the second flexible portion 76.

Further, in the bus bar 7 of the seventh specific example, the bus bar body 70 is formed in a flat plate shape, and then the first spring portion 74b and the second spring portion 74c of the first flexible portion 74 that serve as the tolerance absorbing structure are provided in the first terminal connecting body 71 at a position avoiding a central portion of the bus bar body 70, and the first spring portion 76b and the second spring portion 76c of the second flexible portion 76 that serve as the tolerance absorbing structure are provided in the second terminal connecting body 72 at a position avoiding the central portion of the bus bar body 70. Therefore, the bus bar 7 can connect the first electrode terminal BCa and the second electrode terminal BCa with the shortest possible energization path, and thus, a resistance value or a heat generation amount can be minimized. Further, since the bus bar 7 of the seventh specific example is provided with the tolerance absorbing structures (the first spring portion 74b and the second spring portion 74c of the first flexible portion 74, and the first spring portion 76b and the second spring portion 76c of the second flexible portion 76) at welded portions with the electrode terminals BCa having the highest temperature reduction effect by heat dissipation of the battery cell BC, heat generation of the bus bar 7 itself can be suppressed, and a heat resistant structure (that is, a cross-sectional area of the central portion of the bus bar body 70) can be downsized.

In the bus bar 7 of the seventh specific example, the second spring portions 74c and 76c do not have to be provided, and in this case, the first spring portions 74b and 76b may function as the second spring portions 74c and 76c to absorb the deviations of the positions of the electrode terminals BCa.

### Modification

One modification of the bus bar according to the present invention will be described with reference to FIGS. 12 to 14.

A bus bar of the present modification includes a first bus bar body formed in a flat plate shape. The first bus bar body is arranged between one battery cell BC and the other battery cell BC adjacent to each other. Further, the bus bar of the present modification includes a second bus bar body that is physically and electrically connected to the first bus bar body.

The first bus bar body includes a notch portion or a through-hole portion for exposing the first electrode terminal BCa of one battery cell BC, and is divided into two parts including a first terminal connecting body to which the first electrode terminal BCa is electrically connected via the second bus bar body and a second terminal connecting body whose welding target is the second electrode terminal BCa of the other battery cell BC.

A second bus bar body includes a terminal welded portion that is arranged in the notch portion or the through-hole portion of the first terminal connecting body of the first bus bar body and is welded to the first electrode terminal BCa, a first bus bar welded portion that is welded to the first terminal connecting body, a second bus bar welded portion that is welded to the first terminal connecting body, a first spring portion that is provided between the terminal welded portion and the first bus bar welded portion and is elastically deformable in an arrangement direction of the terminal welded portion and the first bus bar welded portion and an opposite direction thereto, a second spring portion that is provided between the terminal welded portion and the second bus bar welded portion and is elastically deformable in an arrangement direction of the terminal welded portion and the second bus bar welded portion and an opposite direction thereto, and a circuit conductor connecting portion that is physically and electrically connected to a circuit conductor electrically connected to a battery monitoring unit.

The bus bar of the present modification includes the first bus bar body and the second bus bar body having such shapes, so that the first spring portion and the second spring portion of the second bus bar body function as tolerance absorbing structures. For example, even in a case where an interval (so-called inter-terminal pitch) in the arrangement direction of the respective electrode terminals BCa of the two adjacent battery cells BC deviates within a range of design tolerance, the bus bar can be welded to the respective electrode terminals BCa by absorbing the deviation of the inter-terminal pitch with the first spring portion or the second spring portion. In addition, even in a case where the inter-terminal pitch deviates within the range of design tolerance, or a position of the electrode terminal BCa deviates within a range of design tolerance due to thermal expansion or thermal contraction of the battery cell BC during use of the battery module BM, the bus bar can follow the deviation of the inter-cell pitch within the range of design tolerance due to thermal expansion or thermal contraction of the battery cell BC or the deviation of the position of the electrode terminal BCa within the range of design tolerance due to thermal expansion or thermal contraction of the battery cell BC by absorbing the deviation of the inter-terminal pitch or the deviation of the position of the electrode terminal BCa with the first spring portion or the second spring portion.

Further, in the bus bar of the present modification, since the first spring portion and the second spring portion (tolerance absorbing structures) of the second bus bar body are provided at positions avoiding a central portion between the first terminal connecting body and the second terminal connecting body in the first bus bar body, the central portion can have a heat resistant structure without being restricted by the tolerance absorbing structures. Further, since the bus bar of the present modification is provided with the first spring portion and the second spring portion (tolerance absorbing structures) at a welded portion with the electrode terminal BCa having the highest temperature reduction effect by heat dissipation of the battery cell BC, heat generation of the first bus bar body can be suppressed, and the heat resistant structure (that is, a cross-sectional area of a central portion of the first bus bar body) can be downsized.

Hereinafter, specific examples of the bus bar of the present modification will be described.

### First Specific Example

Reference Numeral 101 in FIG. 12 indicates a bus bar of a first specific example in the present modification. The bus bar 101 includes a first bus bar body 110 formed in a flat plate shape by using a conductive material such as metal, and a second bus bar body 120 physically and electrically connected to the first bus bar body 110 (FIG. 12).

The first bus bar body 110 is formed in a rectangular flat plate shape. The first bus bar body 110 is divided into two parts including a rectangular flat-plate-like first terminal connecting body 111 to which the first electrode terminal BCa of one battery cell BC is electrically connected via the second bus bar body 120 and a rectangular flat-plate-like second terminal connecting body 112 whose welding target is the second electrode terminal BCa of the other battery cell BC (FIG. 12). The first terminal connecting body 111 of the first specific example includes a notch portion 111a that exposes the first electrode terminal BCa.

In the first bus bar body 110, the second bus bar body 120 is assembled to the first terminal connecting body 111, a part of the second bus bar body 120 arranged in the notch portion 111a is welded to the first electrode terminal BCa of one battery cell BC by laser welding or the like, and the second terminal connecting body 112 is welded to the second electrode terminal BCa of the other battery cell BC by laser welding or the like in the same manner as in the related art. Therefore, the notch portion 111a is made to overlap the first electrode terminal BCa to expose the first electrode terminal BCa. The notch portion 111a is formed in a quadrangular shape larger than the first electrode terminal BCa and exposes the entire plane (welding surface) of the first electrode terminal BCa. The notch portion 111a illustrated here is formed in a rectangular shape from a side portion of the first terminal connecting body 111 in the arrangement direction of the plurality of battery cells BC toward the second terminal connecting body 112. The second terminal connecting body 112 may be provided with a through-hole for welding.

The second bus bar body 120 is arranged in the notch portion 111a of the first terminal connecting body 111 of the first bus bar body 110, and includes a terminal welded portion 121 that is welded to the first electrode terminal BCa, a first bus bar welded portion 122 that is welded to the first terminal connecting body 111, and a second bus bar welded portion 123 that is welded to the first terminal connecting body 111 (FIG. 12). The second bus bar body 120 further includes a first spring portion 124 that is provided between the terminal welded portion 121 and the first bus bar welded portion 122 and is elastically deformable in an arrangement direction of the terminal welded portion 121 and the first bus bar welded portion 122 and in an opposite direction thereto, and a second spring portion 125 that is provided between the terminal welded portion 121 and the second bus bar welded portion 123 and is elastically deformable in an arrangement direction of the terminal welded portion 121 and the second bus bar welded portion 123 and in an opposite direction thereto (FIG. 12). The second bus bar body 120 further includes a circuit conductor connecting portion 126 that is physically and electrically connected to a circuit conductor (here, a wiring pattern of a flexible printed circuit board) electrically connected to a battery monitoring unit (FIG. 12).

In the second bus bar body 120, the first bus bar welded portion 122, the first spring portion 124, the terminal welded portion 121, the second spring portion 125, and the second bus bar welded portion 123 are arranged in this order in a line. Then, the second bus bar body 120 is connected to the first bus bar body 110 while being oriented in the arrangement direction of the plurality of battery cells BC or the direction orthogonal to the arrangement direction of the plurality of battery cells BC. In the second bus bar body 120 illustrated here, the first bus bar welded portion 122, the first spring portion 124, the terminal welded portion 121, the second spring portion 125, the second bus bar welded portion 123, and the circuit conductor connecting portion 126 are arranged in this order in a line (FIG. 12). The second bus bar body 120 illustrated here is connected to the first bus bar body 110 while being oriented in the direction orthogonal to the arrangement direction of the plurality of battery cells BC (FIG. 12).

The second bus bar body 120 is formed, for example, by bending a rectangular flat-plate-like piece, and the rectangular flat-plate-like first bus bar welded portion 122 and the rectangular flat-plate-like second bus bar welded portion 123 are welded to the first terminal connecting body 111. In the first terminal connecting body 111 illustrated here, piece portions are formed on one side and the other side of the notch portion 111a in the direction orthogonal to the arrangement direction of the plurality of battery cells BC. In the second bus bar body 120, the first bus bar welded portion 122 is welded to the piece portion on one side, and the second bus bar welded portion 123 is welded to the piece portion on the other side (FIG. 12).

A side portion of the first bus bar welded portion 122 that is adjacent to the terminal welded portion 121 (that is, the second bus bar welded portion 123) overlaps the notch portion 111a. The first spring portion 124 is formed in a V shape or a U shape rising from the side portion of the first bus bar welded portion 122 toward a side opposite to the first electrode terminal BCa and folded back toward the first electrode terminal BCa at a tip of the rising portion (FIG. 12). Further, a side portion of the second bus bar welded portion 123 that is adjacent to the terminal welded portion 121 (that is, the first bus bar welded portion 122) overlaps the notch portion 111a. The second spring portion 125 is formed in a V shape or a U shape rising from the side portion of the second bus bar welded portion 123 toward a side opposite to the first electrode terminal BCa and folded back toward the first electrode terminal BCa at a tip of the rising portion (FIG. 12). The first spring portion 124 and the second spring portion 125 are deformed by being bent in the direction orthogonal to the arrangement direction of the plurality of battery cells BC. The terminal welded portion 121 connects between respective end portions of the first spring portion 124 and the second spring portion 125 that are folded back toward the first electrode terminal BCa (FIG. 12). The terminal welded portion 121 illustrated here is formed in a disk shape parallel to the plane (welded surface) of the first electrode terminal BCa. The circuit conductor connecting portion 126 is connected to the other side portion of the second bus bar welded portion 123 and protrudes from the first bus bar body 110 (FIG. 12).

Even in a case where a position of the first electrode terminal BCa or the second electrode terminal BCa deviates within a range of design tolerance due to thermal expansion or thermal contraction of one battery cell BC or the other battery cell BC during use of the battery module BM, the bus bar 101 of the first specific example can follow the deviation of the position of the electrode terminal BCa within the range of design tolerance due to the thermal expansion or thermal contraction of one battery cell BC or the other battery cell BC by absorbing the deviation of the position of the electrode terminal BCa with the first spring portion 124 and the second spring portion 125.

Further, in the bus bar 101 of the first specific example, the first bus bar body 110 is formed in a flat plate shape, and then, the second bus bar body 120 with the tolerance absorbing structures (the first spring portion 124 and the second spring portion 125) is assembled to the first terminal connecting body 111 at a position avoiding a central portion between the first terminal connecting body 111 and the second terminal connecting body 112 in the first bus bar body 110. Therefore, the bus bar 101 can connect the first electrode terminal BCa and the second electrode terminal BCa with the shortest possible energization path, and thus, a resistance value or a heat generation amount can be minimized. Further, since the bus bar 101 of the first specific example is provided with the tolerance absorbing structures (the first spring portion 124 and the second spring portion 125) at a welded portion with the electrode terminal BCa having the highest temperature reduction effect by heat dissipation of the battery cell BC, heat generation of the first bus bar body 110 can be suppressed, and the heat resistant structure (that is, a cross-sectional area of a central portion of the first bus bar body 110) can be downsized.

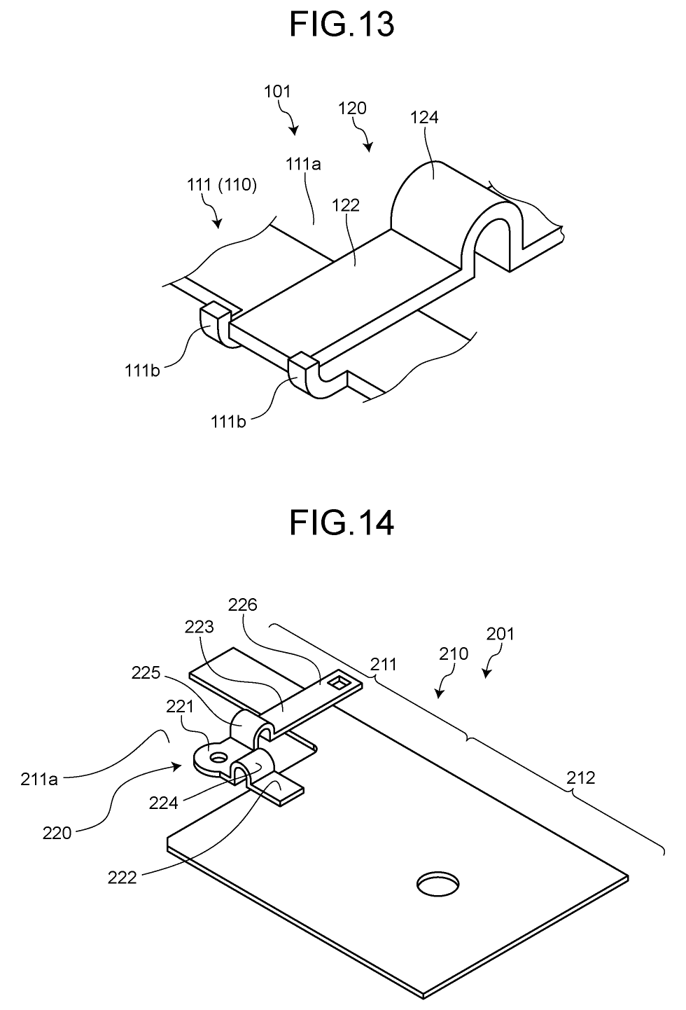

The first terminal connecting body 111 of the first bus bar body 110 may be provided with clamping portions 111b that hold the first bus bar welded portions 122 of the second bus bar body 120 from both sides (FIG. 13). For example, each of the clamping portions 111b is used to position the terminal welded portion 121 of the second bus bar body 120 in the arrangement direction of the plurality of battery cells BC when the first bus bar welded portion 122 is welded to the first terminal connecting body 111.

### Second Specific Example

Reference Numeral 201 in FIG. 14 indicates a bus bar of a second specific example in the present modification. The bus bar 201 includes a first bus bar body 210 formed in a flat plate shape by using a conductive material such as metal, and a second bus bar body 220 physically and electrically connected to the first bus bar body 210 (FIG. 14).

The first bus bar body 210 is formed in a rectangular flat plate shape. The first bus bar body 210 is divided into two parts including a rectangular flat-plate-like first terminal connecting body 211 to which the first electrode terminal BCa of one battery cell BC is electrically connected via the second bus bar body 220 and a rectangular flat-plate-like second terminal connecting body 212 whose welding target is the second electrode terminal BCa of the other battery cell BC (FIG. 14). The first terminal connecting body 211 of the second specific example includes a notch portion 211a that exposes the first electrode terminal BCa.

In the first bus bar body 210, the second bus bar body 220 is assembled to the first terminal connecting body 211, a part of the second bus bar body 220 arranged in the notch portion 211a is welded to the first electrode terminal BCa of one battery cell BC by laser welding or the like, and the second terminal connecting body 212 is welded to the second electrode terminal BCa of the other battery cell BC by laser welding or the like in the same manner as in the related art. Therefore, the notch portion 211a is made to overlap the first electrode terminal BCa to expose the first electrode terminal BCa. The notch portion 211a is formed in a quadrangular shape larger than the first electrode terminal BCa and exposes the entire plane (welding surface) of the first electrode terminal BCa. The notch portion 211a illustrated here is formed in a rectangular shape from one corner portion on a side portion side of the first terminal connecting body 211 in the arrangement direction of the plurality of battery cells BC. The second terminal connecting body 212 may be provided with a through-hole for welding.

The second bus bar body 220 is arranged in the notch portion 211a of the first terminal connecting body 211 of the first bus bar body 210, and includes a terminal welded portion 221 that is welded to the first electrode terminal BCa, a first bus bar welded portion 222 that is welded to the first terminal connecting body 211, and a second bus bar welded portion 223 that is welded to the first terminal connecting body 211 (FIG. 14). The second bus bar body 220 further includes a first spring portion 224 that is provided between the terminal welded portion 221 and the first bus bar welded portion 222 and is elastically deformable in an arrangement direction of the terminal welded portion 221 and the first bus bar welded portion 222 and in an opposite direction thereto, and a second spring portion 225 that is provided between the terminal welded portion 221 and the second bus bar welded portion 223 and is elastically deformable in an arrangement direction of the terminal welded portion 221 and the second bus bar welded portion 223 and in an opposite direction thereto (FIG. 14). The second bus bar body 220 further includes a circuit conductor connecting portion 226 that is physically and electrically connected to a circuit conductor (here, a wiring pattern of a flexible printed circuit board) electrically connected to a battery monitoring unit (FIG. 14).

The second bus bar body 220 is connected to the first bus bar body 210 such that the first bus bar welded portion 222, the first spring portion 224, and the terminal welded portion 221 are arranged in this order in a first direction, and the terminal welded portions 221, the second spring portion 225, and the second bus bar welded portion 223 are arranged in this order in a second direction orthogonal to the first direction, the first direction being directed in the arrangement direction of the plurality of battery cells BC, and the second direction being directed in the direction orthogonal to the arrangement direction of the plurality of battery cells BC (FIG. 14).

The second bus bar body 220 is formed, for example, by bending an L-shaped flat-plate-like piece, and the rectangular flat-plate-like first bus bar welded portion 222 included in one side piece portion of the L shape and the rectangular flat-plate-like second bus bar welded portion 223 included in the other side piece portion of the L shape are welded to the first terminal connecting body 211. In the first terminal connecting body 211 illustrated here, piece portions are formed on a side of the notch portion 211a that is adjacent to the second terminal connecting body 212 in the arrangement direction of the plurality of battery cells BC and on one side of the notch portion 111a in the direction orthogonal to the arrangement direction of the plurality of battery cells BC. In the second bus bar body 120, the first bus bar welded portion 222 is welded to the piece portion on the side adjacent to the second terminal connecting body 212, and the second bus bar welded portion 223 is welded to the piece portion on the one side in the orthogonal direction (FIG. 14).

A side portion of the first bus bar welded portion 222 that is adjacent to the terminal welded portion 221 overlaps the notch portion 211a. The first spring portion 224 is formed in a V shape or a U shape rising from the side portion of the first bus bar welded portion 222 toward a side opposite to the first electrode terminal BCa and folded back toward the first electrode terminal BCa at a tip of the rising portion (FIG. 14). The first spring portion 224 is deformed by being bent in the arrangement direction of the plurality of battery cells BC. A side portion of the second bus bar welded portion 223 that is adjacent to the terminal welded portion 221 overlaps the notch portion 211a. The second spring portion 225 is formed in a V shape or a U shape rising from the side portion of the second bus bar welded portion 223 toward a side opposite to the first electrode terminal BCa and folded back toward the first electrode terminal BCa at a tip of the rising portion (FIG. 14). The second spring portion 225 is deformed by being bent in the direction orthogonal to the arrangement direction of the plurality of battery cells BC. The terminal welded portion 221 connects between an end portion of a tip of the first spring portion 224 that is folded back toward the first electrode terminal BCa and an end portion of a tip of the second spring portion 225 that is folded back toward the first electrode terminal BCa (FIG. 14). The terminal welded portion 221 illustrated here is formed in a disk shape parallel to the plane (welded surface) of the first electrode terminal BCa. The circuit conductor connecting portion 226 is connected to the other side portion of the second bus bar welded portion 223 and protrudes from the first bus bar body 210 (FIG. 14).

Even in a case where a position of the first electrode terminal BCa or the second electrode terminal BCa deviates within a range of design tolerance due to thermal expansion or thermal contraction of one battery cell BC or the other battery cell BC during use of the battery module BM, the bus bar 201 of the second specific example can follow the deviation of the position of the electrode terminal BCa within the range of design tolerance due to the thermal expansion or thermal contraction of one battery cell BC or the other battery cell BC by absorbing the deviation of the position of the electrode terminal BCa with the first spring portion 224 or the second spring portion 225. Furthermore, even in a case where the inter-terminal pitch deviates within a range of design tolerance due to thermal expansion or thermal contraction of one battery cell BC or the other battery cell BC during use of the battery module BM, the bus bar 201 of the second specific example can follow the deviation of the inter-cell pitch within the range of design tolerance due to the thermal expansion or thermal contraction of one battery cell BC or the other battery cell BC by absorbing the deviation of the inter-terminal pitch with the first spring portion 224.

Further, in the bus bar 201 of the second specific example, the first bus bar body 210 is formed in a flat plate shape, and then, the second bus bar body 220 with the tolerance absorbing structures (the first spring portion 224 and the second spring portion 225) is assembled to the first terminal connecting body 211 at a position avoiding a central portion between the first terminal connecting body 211 and the second terminal connecting body 212 in the first bus bar body 210. Therefore, the bus bar 201 can connect the first electrode terminal BCa and the second electrode terminal BCa with the shortest possible energization path, and thus, a resistance value or a heat generation amount can be minimized. Further, since the bus bar 201 of the second specific example is provided with the tolerance absorbing structures (the first spring portion 224 and the second spring portion 225) at a welded portion with the electrode terminal BCa having the highest temperature reduction effect by heat dissipation of the battery cell BC, heat generation of the first bus bar body 210 can be suppressed, and the heat resistant structure (that is, a cross-sectional area of a central portion of the first bus bar body 210) can be downsized.

The bus bar according to the present embodiment includes the bus bar body having such a structure, or includes the first bus bar body and the second bus bar body having such structures, so that the spring portion functions as a tolerance absorbing structure. For example, even in a case where an interval (so-called inter-terminal pitch) in the arrangement direction of the respective electrode terminals of the two adjacent battery cells deviates within a range of design tolerance, the bus bar can be welded to the respective electrode terminals by absorbing the deviation of the inter-terminal pitch with the spring portion. In addition, even in a case where the inter-terminal pitch deviates within the range of design tolerance, or a position of the electrode terminal deviates within a range of design tolerance due to thermal expansion or thermal contraction of the battery cell during use of the battery module, the bus bar can follow the deviation of the inter-cell pitch within the range of design tolerance due to thermal expansion or thermal contraction of the battery cell or the deviation of the position of the electrode terminal within the range of design tolerance due to thermal expansion or thermal contraction of the battery cell by absorbing the deviation of the inter-terminal pitch or the deviation of the position of the electrode terminal with the spring portion. In the bus bar according to the present embodiment, the spring portion (tolerance absorbing structure) is provided at a location avoiding a central portion between the first terminal connecting body and the second terminal connecting body, so that the central portion can have a heat resistant structure without being restricted by the tolerance absorbing structure. Furthermore, since the bus bar according to the present embodiment is provided with the spring portion (tolerance absorbing structure) at a welded portion with the electrode terminal having the highest temperature reduction effect by thermal dissipation of the battery cell, heat generation of the bus bar itself can be suppressed, and the heat resistant structure (that is, a cross-sectional area of the central portion) can be downsized.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A bus bar comprising:
a bus bar body that is formed in a flat plate shape and is arranged between one battery cell and an other battery cell adjacent to each other in a battery module in which a plurality of battery cells are arranged, wherein
the bus bar body is divided into two parts including a first terminal connecting body whose welding target is a first electrode terminal of the one battery cell and a second terminal connecting body whose welding target is a second electrode terminal of the other battery cell,
at least one of the first terminal connecting body and the second terminal connecting body includes a through-hole that exposes the electrode terminal as the welding target, and a flexible portion that protrudes from an outer peripheral edge portion of the through-hole toward a hole center and has flexibility, and
the flexible portion includes a terminal welded portion that is welded to the electrode terminal as the welding target, and a spring portion that is provided between the terminal welded portion and a fixed end on an outer peripheral edge portion side of the through-hole and is elastically deformable in a protruding direction of the spring portion and in an opposite direction to the protruding direction of the spring portion.

2. The bus bar according to claim 1, wherein
the flexible portion is formed in a cantilever shape protruding from the outer peripheral edge portion of the through-hole toward the hole center in a direction orthogonal to an arrangement direction of the plurality of battery cells, and
the terminal welded portion is provided at a free end of the flexible portion.

3. The bus bar according to claim 1, wherein
the flexible portion is formed in a cantilever shape protruding from the outer peripheral edge portion of the through-hole toward the hole center in an arrangement direction of the plurality of battery cells, and
the terminal welded portion is provided at a free end of the flexible portion.

4. The bus bar according to claim 1, wherein
the first terminal connecting body includes a first through-hole as the through-hole and a first flexible portion as the flexible portion,
the second terminal connecting body includes a second through-hole as the through-hole and a second flexible portion as the flexible portion,
the first flexible portion is formed in a cantilever shape protruding from an outer peripheral edge portion of the first through-hole toward a hole center in a direction orthogonal to an arrangement direction of the plurality of battery cells,
the terminal welded portion of the first flexible portion is provided at a free end of the first flexible portion and welded to the first electrode terminal,
the second flexible portion is formed in a cantilever shape protruding from an outer peripheral edge portion of the second through-hole toward a hole center in the arrangement direction, and
the terminal welded portion of the second flexible portion is provided at a free end of the second flexible portion and is welded to the second electrode terminal.

5. The bus bar according to claim 2, wherein a pair of the flexible portions is provided in opposite protruding directions.

6. The bus bar according to claim 3, wherein a pair of the flexible portions is provided in opposite protruding directions.

7. The bus bar according to claim 4, wherein a pair of the flexible portions is provided in opposite protruding directions.

8. The bus bar according to claim 1, wherein
the through-hole is formed in a circular shape,
the flexible portion is formed in a cantilever shape protruding from the outer peripheral edge portion of the through-hole toward the hole center, and a plurality of the flexible portions are provided at equal intervals over an entire circumference of the through-hole, and
the terminal welded portion is provided at a free end of the flexible portion.

9. The bus bar according to claim 1, wherein
the flexible portion is formed in a double-supported beam shape protruding from two positions facing each other on the outer peripheral edge portion of the through-hole toward the hole center in a direction orthogonal to an arrangement direction of the plurality of battery cells,
the terminal welded portion is arranged at a center of the flexible portion and at the hole center of the through-hole, and
the spring portion is provided at each of a position between the terminal welded portion and one fixed end and a position between the terminal welded portion and an other fixed end.

10. The bus bar according to claim 1, wherein
the flexible portion is formed in a double-supported beam shape protruding from two positions facing each other on the outer peripheral edge portion of the through-hole toward the hole center in an arrangement direction of the plurality of battery cells,
the terminal welded portion is arranged at a center of the flexible portion and at the hole center of the through-hole, and
the spring portion is provided at each of a position between the terminal welded portion and one fixed end and a position between the terminal welded portion and an other fixed end.

11. The bus bar according to claim 1, wherein
the first terminal connecting body includes a first through-hole as the through-hole and a first flexible portion as the flexible portion,
the second terminal connecting body includes a second through-hole as the through-hole and a second flexible portion as the flexible portion,
the first flexible portion is formed in a double-supported beam shape protruding from two positions facing each other on an outer peripheral edge portion of the first through-hole toward a hole center in a direction orthogonal to an arrangement direction of the plurality of battery cells,
the terminal welded portion of the first flexible portion is arranged at a center of the first flexible portion and at the hole center of the first through-hole and is welded to the first electrode terminal,
the spring portion of the first flexible portion is provided at each of a position between the terminal welded portion and one fixed end and a position between the terminal welded portion and an other fixed end in the first flexible portion,
the second flexible portion is formed in a double-supported beam shape protruding from two positions facing each other on an outer peripheral edge portion of the second through-hole toward a hole center in the arrangement direction,
the terminal welded portion of the second flexible portion is arranged at a center of the second flexible portion and at the hole center of the second through-hole and is welded to the second electrode terminal, and
the spring portion of the second flexible portion is provided at each of a position between the terminal welded portion and one fixed end and a position between the terminal welded portion and an other fixed end in the second flexible portion.

12. A bus bar comprising:
a first bus bar body formed in a flat plate shape and arranged between one battery cell and an other battery cell adjacent to each other in a battery module in which a plurality of battery cells are arranged; and
a second bus bar body physically and electrically connected to the first bus bar body, wherein
the first bus bar body includes a notch portion or a through-hole portion for exposing a first electrode terminal of the one battery cell and is divided into two parts including a first terminal connecting body to which the first electrode terminal is electrically connected via the second bus bar body and a second terminal connecting body whose welding target is a second electrode terminal of the other battery cell, and
the second bus bar body includes a terminal welded portion that is arranged in the notch portion or the through-hole portion of the first terminal connecting body and is welded to the first electrode terminal, a first bus bar welded portion that is welded to the first terminal connecting body, a second bus bar welded portion that is welded to the first terminal connecting body, a first spring portion that is provided between the terminal welded portion and the first bus bar welded portion and is elastically deformable in an arrangement direction of the terminal welded portion and the first bus bar welded portion and an opposite direction to the arrangement direction of the terminal welded portion and the first bus bar welded portion, a second spring portion that is provided between the terminal welded portion and the second bus bar welded portion and is elastically deformable in an arrangement direction of the terminal welded portion and the second bus bar welded portion and an opposite direction to the arrangement direction of the terminal welded portion and the second bus bar welded portion, and a circuit conductor connecting portion that is physically and electrically connected to a circuit conductor electrically connected to a battery monitoring unit.

13. The bus bar according to claim 12, wherein
the second bus bar body is connected to the first bus bar body such that the first bus bar welded portion, the first spring portion, the terminal welded portion, the second spring portion, and the second bus bar welded portion are arranged in this order in a line while being oriented in an arrangement direction of the plurality of battery cells or a direction orthogonal to the arrangement direction of the plurality of battery cells.

14. The bus bar according to claim 12, wherein
the second bus bar body is connected to the first bus bar body such that the first bus bar welded portion, the first spring portion, and the terminal welded portion are arranged in this order in a first direction, and the terminal welded portions, the second spring portion, and the second bus bar welded portion are arranged in this order in a second direction orthogonal to the first direction, the first direction being directed in an arrangement direction of the plurality of battery cells, and the second direction being directed in a direction orthogonal to the arrangement direction of the plurality of battery cells.
